(19) United States
(12) Patent Application Publication
(10) Pub. No.: US 2005/0264473 A1
(43) Pub. Date: Dec. 1, 2005

(54) Modular lighted display and method therefor

(76) Inventor: Gary M. Sibbett, Henderson, NV (US)

Correspondence Address: WEISS & MOY PC, 4204 NORTH BROWN AVENUE, SCOTTSDALE, AZ, 85251, US

(21) Appl. No.: 10/835,206

(22) Filed: Apr. 29, 2004

(51) Int. Cl. G09G 3/06

(52) U.S. Cl. 345/44

(57) ABSTRACT

A modular lighted display and method therefore. An electronic driving device provides an electrical signal to power an attachable illumination device. An illumination device has a front viewing surface and input contacts to receive an electrical signal for emitting light from the front viewing surface.

### RELATED APPLICATION

This application is related to the utility patent application filed concurrently herewith in the name of the same inventor entitled “MOUNTABLE ILLUMINABLE DISPLAY.”

### FIELD OF THE INVENTION

This invention relates generally to lighted displays, and more particularly, to modular lighted displays that may be attached to an article of manufacture.

### DESCRIPTION OF THE RELATED ART

Lighted displays, which provide an illuminated design on an otherwise un-illuminated surface have become increasingly popular. Because of the attention attracted by an illuminated sign or design, illuminated displays have found uses in safety equipment, commercial advertisements, personal fashion, and many other applications. Frequently, such devices provide colorful designs and feature additional effects such as a flashing behavior to attract additional attention.

Typically, lighted displays are of an electroluminescence (EL) type or of a light emitting diode (LED) type. The EL displays commonly use an electroluminescent material such as a sheet containing phosphor layer between two conductive layers. The phosphor layer emits light when an alternating electrical signal is provided to the conductive layers, usually requiring voltages from about 30V to 220V and frequencies from 50 Hz to 3 kHz. Such requirements are commonly satisfied by coupling a standard battery to an EL driver circuit containing an inverter. EL technology provides the benefits of high efficiency, flexible materials, and providing a plane solid light source.

LED displays commonly use one or more LEDs to emit light in response to an applied electrical signal. Unlike the planar source of EL displays, the LEDs emit light from a single source in response to a DC power supply. LED displays typically use a colorful surface having one or more LEDS positioned on the surface to attract additional attention, or have one or more LEDs under a translucent film having a design for a back-lighting effect as the LED emits light through the translucent film.

Both EL and LED displays have been mounted on or built into items such as headwear, shoes, jewelry, and promotional-type materials such as coffee mugs and memo pad holders that are typically given away to consumers to promote a product or service. However, items manufactured with displays are limited by only having the capacity for use with the display provided, and manufacturers incur significant costs in designing and manufacturing such displays into each item to be manufactured. Displays designed to be attached onto existing products, such as safety lighting devices for shoes, also suffer the limitation that when the consumer or producer desires to change the display design or pattern, the entire device must be remanufactured or repurchased.

A need therefore exists to provide a lighted display that overcomes these limitations and disadvantages of present lighted displays. Specifically, a need exists to reduce the cost of manufacture of multiple items featuring common displays. A need also exists to reduce the cost of remanufacturing an item already having a lighted display to provide a different lighted display. A need also exists to reduce the cost to consumers for replacing or changing a lighted display on an item the consumer already uses.

The present invention satisfies these needs, and provides other, related, advantages.

### SUMMARY OF THE INVENTION

The foregoing objectives are achieved in the modular lighted display and method therefor.

In accordance with one embodiment of the present invention, an electronic driving device for an attachable lighted display is disclosed. It comprises, in combination, input contacts for receiving an electrical input; a driver circuit coupled to the input contacts for transforming the electrical input to illuminate an attachable lighted display; output contacts coupled to the driver circuit; and display coupling means for coupling an attachable lighted display into electrical contact with the output contacts.

In accordance with another embodiment of the present invention, an illumination device for use as an attachable lighted display is disclosed. It consists essentially of: a front viewing surface; a back surface;

electroluminescence means for emitting light from the front viewing surface in response to an electrical signal received by the illumination device; and electrical contacts proximate the back surface and electrically coupled to the electroluminescence means for receiving the electrical signal.

In accordance with another embodiment of the present invention, an illumination device for use as an attachable lighted display is disclosed. It consists essentially of: a front viewing surface; means for emitting light from the front viewing surface in response to an electrical signal received by said illumination device; electrical contacts electrically coupled to the light emitting means; and coupling means for coupling an external electronic display driver to the electrical contacts.

In accordance with another embodiment of the present invention, a modular lighted display device is disclosed. It comprises, in combination: a driver device having output contacts for supplying an electrical signal; an illumination device having a front viewing surface and means for emitting light from the front viewing surface in response to the electrical signal from the driver device, the illumination device further having input contacts electrically coupled to the emitting means for receiving the electrical signal; and means for coupling the illumination module to the driver device so that the electrical signal is transmitted between the output contacts of the driver device and the input contacts of the illumination device.

In accordance with another embodiment of the present invention, a method for providing an illuminable display to an item is disclosed. It comprises the steps of: providing a mounting surface for the illuminable display; providing a driver device for providing an electrical signal for an illumination device, the driver device comprising means for coupling the illumination device to the driver device so that the illumination device is electrically coupled to the driver device, the driver device further comprising means for coupling the driver device to the mounting surface; coupling the driver device to the mounting surface; providing an illumination device comprising a viewing surface and means for emitting light from the viewing surface in response to the electrical signal from the driver device; and coupling the illumination device to the driver device.

The foregoing and other objects, features, and advantages of the invention will be apparent from the following, more particular, description of the preferred embodiment of the invention, as illustrated in the accompanying drawings.

### BRIEF DESCRIPTION OF THE DRAWINGS

FIG. 1 is an illustration depicting a perspective exploded view of a modular lighted display having a clasping peripheral retaining element, an illumination module, and a driving module in accordance with a preferred embodiment of the present invention.

FIG. 1A is an illustration depicting a partial cross-sectional side view of the modular lighted display of FIG. 1 in accordance with a preferred embodiment of the present invention.

FIG. 2 is an illustration depicting a perspective exploded view of a modular lighted display having a threaded peripheral retaining element, an illumination module, and a driving module in accordance with a preferred embodiment of the present invention.

FIG. 2A is an illustration depicting a partial cross-sectional side view of the modular lighted display of FIG. 2 in accordance with a preferred embodiment of the present invention.

FIG. 3A is an illustration depicting a perspective view of a modular lighted display having an illumination module, a driving module, and a magnetic attaching mechanism in accordance with a preferred embodiment of the present invention.

FIG. 3B is an illustration depicting a perspective view of a modular lighted display having an illumination module, a driving module, and attaching clips in accordance with a preferred embodiment of the present invention.

FIG. 3C is an illustration depicting a perspective view of a modular lighted display having an illumination module, a driving module, and a slot-and-groove attaching mechanism in accordance with a preferred embodiment of the present invention.

FIG. 4 is an illustration depicting a perspective view of a front viewing surface and a back surface of an illumination device for use as an attachable lighted display having LEDs in accordance with a preferred embodiment of the present invention.

FIG. 5A is a schematic diagram of a driving device for use with an electroluminescent attachable lighted display in accordance with a preferred embodiment of the present invention.

FIG. 5B is a schematic diagram of a driving device for use with an LED attachable lighted display in accordance with a preferred embodiment of the present invention.

FIG. 6 is a cross-sectional side view of an electroluminescent illumination device diagram for use with an attachable lighted display in accordance with a preferred embodiment of the present invention.

FIG. 7 is a perspective exploded view of modular lighted display having a peripheral retaining element, an illumination module, a driving module, and a mounting surface on a sweatshirt in accordance with a preferred embodiment of the present invention.

FIG. 8 is a perspective exploded view of modular lighted display having a peripheral retaining element, an illumination module, a driving module, and a mounting surface on a cup in accordance with a preferred embodiment of the present invention.

FIG. 9 is a partially-exploded perspective view of modular lighted display having an illumination module, a driving module, and a mounting surface on a pendant in accordance with a preferred embodiment of the present invention.

FIG. 10 is a perspective exploded view of modular lighted display having a peripheral retaining element, an illumination module, a driving module, and a mounting surface on a baseball in accordance with a preferred embodiment of the present invention.

FIG. 11 is a partially-exploded perspective view of modular lighted display having an illumination module, a driving module, and a mounting surface on a hat in accordance with a preferred embodiment of the present invention.

FIG. 12 is a perspective view of modular lighted display having a mounting surface on a backpack in accordance with a preferred embodiment of the present invention.

FIG. 13 is a perspective view of modular lighted display having a mounting surface on a compact disc case in accordance with a preferred embodiment of the present invention.

FIG. 14 is a perspective view of modular lighted display having a mounting surface on a memo pad container in accordance with a preferred embodiment of the present invention.

FIG. 15 is a perspective view of modular lighted display having a mounting surface on a lunchbox in accordance with a preferred embodiment of the present invention.

### DESCRIPTION OF EMBODIMENTS OF THE INVENTION

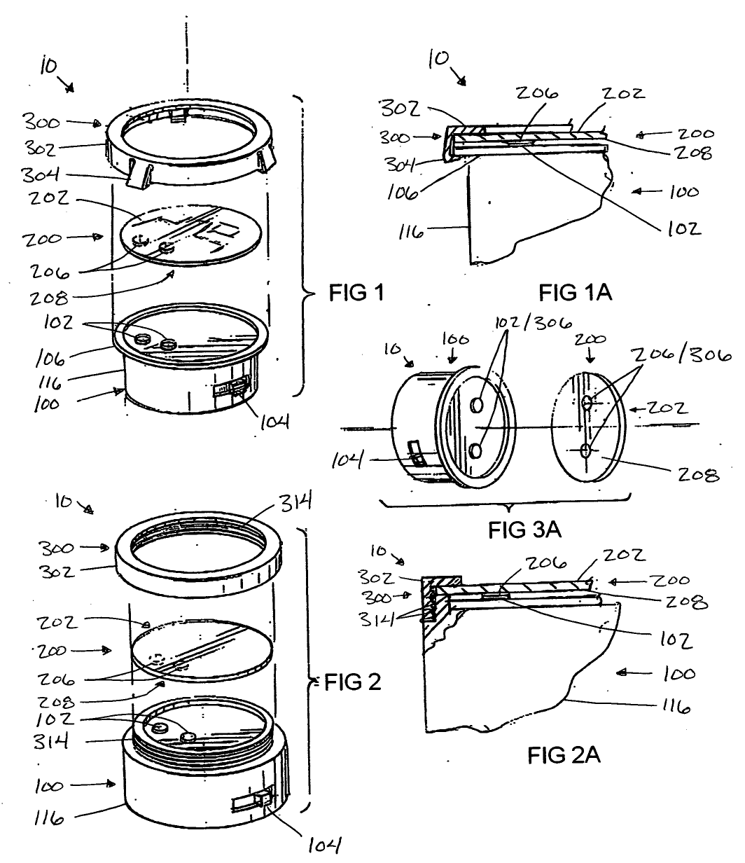

With reference now to the figures, and in particular to FIG. 1, a modular lighted display device 10 is shown in accordance with an embodiment of the present invention. It comprises, in combination, a driver device 100 having output contacts 102 for supplying an electrical signal, and an illumination device 200 having a front viewing surface 202 and means for emitting light 204 from the front viewing surface 202 in response to the electrical signal from the driver device 100. The illumination device 200 further has input contacts 206 electrically coupled to the light emitting means 204 for receiving the electrical signal. The modular lighted display 10 further comprises means for coupling 300 the illumination device 200 to the driver device 100 so that the electrical signal is transmitted between the output contacts 102 of the driver device 100 and the input contacts 206 of the illumination device 200.

As depicted in FIG. 1, the driver device 100 is shown having an on-off switch 104 and a protruding lip 106 around the surface housing the output contacts 102. The illumination device 200 is shown as a flat element having a design on the front viewing surface 202 and input contacts 206 on the back surface 208. The illumination device 200 and driver device 100 are oriented so that the input contacts 206 and output contacts 102 are aligned, ensuring electrical coupling between the illumination device 200 and driver device 100 when assembled. Although both the input contacts 206 and output contacts 102 are depicted as a pair of separated protruding cylindrical metallic elements, it is within the spirit and scope of the present invention that the input contacts 206 and output contacts 102 may be of any size and shape that allow an electrical coupling between the driver device 100 and illumination device 200 when the modular lighted display 10 is assembled. Furthermore, it is within the spirit and scope of the present invention that any number of input contacts 206 and output contacts 102 may be provided. For example, the illumination device 200 may have several light emitting elements, each coupled to one or more input contacts 206 so that the driver device 100 may provide different electrical signals on multiple output contacts 102 to desired light emitting elements.

The illumination device 200 may be coupled to the driver device 100 in FIG. 1 with a peripheral retaining element 302, depicted as a ring having clasps 304. The clasps 304 engage the lip 106 of the driver device 100 to securely hold the illumination device 200 against the driver device 100 when assembled. FIG. 1A shows a partial cross-sectional side view of the modular lighted display 10 of FIG. 1 in an assembled configuration.

The modular design of the present invention 10 provides several advantages. The driving device 100 and the illumination device 200 may be manufactured separately and later assembled, or may be provided by different manufacturers following standardized design criteria to ensure interoperability between driver devices 100 and illumination devices 200 from different manufacturers. Furthermore, because typically the driver devices 100 are more expensive to manufacture than the illumination devices 200, a variety of lighted displays may be provided to consumers efficiently and quickly by using an inventory of standard driver devices 100 with a number of differing illumination devices 200 that may be more quickly and inexpensively designed and manufactured in response to quickly-changing market desires.

Further, the modular design of the present invention 10 offers consumers the possibility of customizing their lighted display by replacing one illumination device 200 with another, using a single driver device 100. Because illumination devices 200 may be produced more quickly and at less cost than a non-modular lighted display, merchants may provide a wide selection of fashionable, inexpensive and interchangeable illumination devices 200 for consumers already having a driver device 100 in their possession. Consumers may collect illumination devices 200 having different designs, such as for sports teams or cartoon characters, and select which to fasten to a driver device 100 in accordance with current fashion or a specific occasion, such as attending sporting event.

In one embodiment of the present invention, the light emitting device 200 comprises an electroluminescence (EL) lamp 210. The driver device 100 further comprises input contacts 108 for receiving an electrical input and a driver circuit for an EL lamp 110 coupled to the input contacts 108 and to the output contacts 102 for transforming the electrical input into the electrical signal for powering the EL lamp 210. The input contacts 108 may be coupled to, for example, a battery (not shown) or AC power supply (not shown), for providing power to the driver device 100.

In another embodiment of the present invention, the light emitting means 204 comprises a light emitting diode (LED) 212. The driver device 100 may comprise a simple LED driver circuit 112 to activate the LED 212 in a desired manner, for example, a continual DC signal for maintaining illumination or intermittent signal for flashing.

It should be understood that it is within the spirit and scope of the present invention that the light emitting device 200 comprise multiple EL lamps, or multiple LEDs, or any combination of EL lams and LEDS as may be desired. In addition, although the illumination module 200 as depicted in FIG. 1 is substantially circular planar, the illumination module 200 may be of any geometric shape as long as it is capable of emitting light from a front viewing surface in response to an electrical signal provided at the input contacts 108. For example, the illumination module 200 may be semi-spherical (not shown), or as another example may be substantially planar with an irregular shape, such as a heart (see FIG. 9).

An electronic driver device 100 for an attachable lighted display is depicted in FIGS. 1, 2, 3A, 3B, and 3C in accordance with an embodiment of the present invention. It comprises, in combination: input contacts 108 for receiving an electrical input; a driver circuit 110 and 112 coupled to the input contacts 108 for transforming the electrical input to illuminate an attachable lighted display; output contacts 102 coupled to the driver circuit 110 or 112; and display coupling means 300 for coupling an attachable lighted display into electrical contact with the output contacts 102. Preferably, the attachable lighted display is an illumination device 200 as described herein. However it is within the spirit and scope of the present invention that the attachable lighted display is not an illumination device 200, as long as the attachable lighted display is illuminable by the driver device 100. For example, the attachable lighted display may be a light bulb (not shown) dimensioned to couple to the driver device 100.

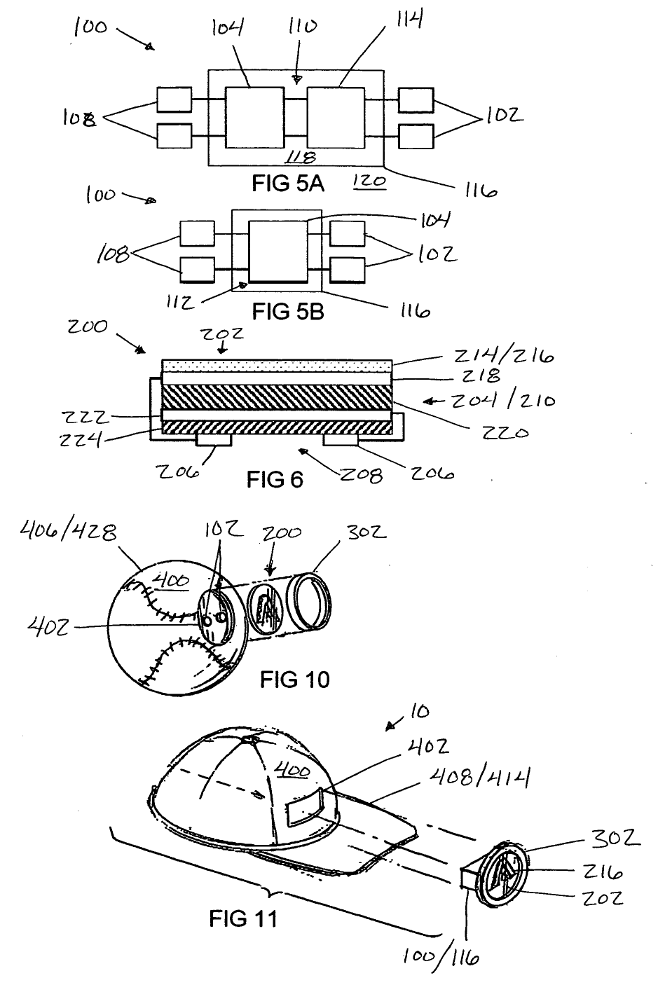

Referring now to FIG. 5A, an embodiment of the present invention is depicted with the driver circuit 110 comprising an inverter 114 for illuminating an electroluminescent (EL) lamp. Preferably the inverter 114 transforms an electrical input into an electrical signal of sufficient voltage and frequency to illuminate an EL lamp, typically requiring a voltage in the range of about 30V to 220V and a frequency from 50 Hz to 3 kHz, with optimal results tending to occur at about 60-110V and 400-800 Hz. Although in the present embodiment, a driver circuit 110 comprises an inverter 114 for illuminating an EL lamp, it should be understood that substantial benefits may be obtained by not having the driver circuit 110 comprise an inverter 114 for powering an EL lamp. For example, the driver circuit 112 depicted in FIG. 5B may be used for providing a DC electrical signal for an attachable lighted display having an LED.

Additional benefits may be obtained by introducing additional control elements in the driver circuit 110 that may modify the electrical signal on the output contacts 102 in response to various conditions. For example, nearby movement, a position or orientation change, ambient light levels, or receipt of an external signal such as a wireless transmission may be used to modify the electrical signal on the output contacts 102.

Preferably, the driver device 100 further comprises a driver housing 116 having an interior 118 and an exterior 120, with the driver circuit 110 being proximate the interior 118 of said driver housing 116, and the output contacts 102 being proximate the exterior 120 of the driver housing 116. However, it should be clearly understood that substantial benefit may be obtained by not having a driver housing 116 and instead having the driver components being positioned separately, as long as the driver device 100 can function to power an attachable lighted display.

Preferably, the driver housing 116 further comprises a battery compartment 122. By providing a driver housing 116 with a battery compartment 122, the driver device 100 may be manufactured and used easily as a portable self-contained unit without requiring external electrical connections or wiring, and provide benefits such as increased safety and pleasing aesthetics.

In accordance with another embodiment of the present inventions, an illumination device 200 for use as an attachable lighted display is depicted in FIGS. 1 and 2. It consists essentially of: a front viewing surface 202; a back surface 208; electroluminescence means 210 for emitting light from the front viewing surface 202 in response to an electrical signal received by the illumination device 200; and electrical contacts 206 proximate the back surface 208 and electrically coupled to the electroluminescence means 210 for receiving the electrical signal. Preferably, the front viewing surface 202 comprises a deposited layer 214 forming a visual pattern 216 such as depicted in FIG. 10. The deposited layer is preferably provided by a method such as silk-screening or printing directly onto the front viewing surface 202. However, is should be clearly understood substantial benefits may be obtained by the front viewing surface 202 not comprising a deposited layer 214 forming a visual pattern 216, and instead a visual pattern 216 may be formed by other methods, for example, by supplying an external film (not shown) having a visual pattern 216, or no visual pattern 216 may be provided at all.

FIG. 6 provides a cross-sectional side view of an electroluminescent (EL) illumination device in accordance with a preferred embodiment of the present invention. The EL material comprises a transparent electrode layer 218 on a flexible substrate phosphor layer 220, a back electrode layer 222, and a protective layer 224. The transparent electrode layer 218 and back electrode layer 222 are electrically coupled to the input contacts 206. The front viewing surface 202 comprises a deposited layer 214 forming a visual pattern 216. However, it should be understood that the use of material structures other than that depicted in FIG. 6 are within the spirit and scope of the present invention, as long as they provide an electroluminescence effect in response to an electrical signal.

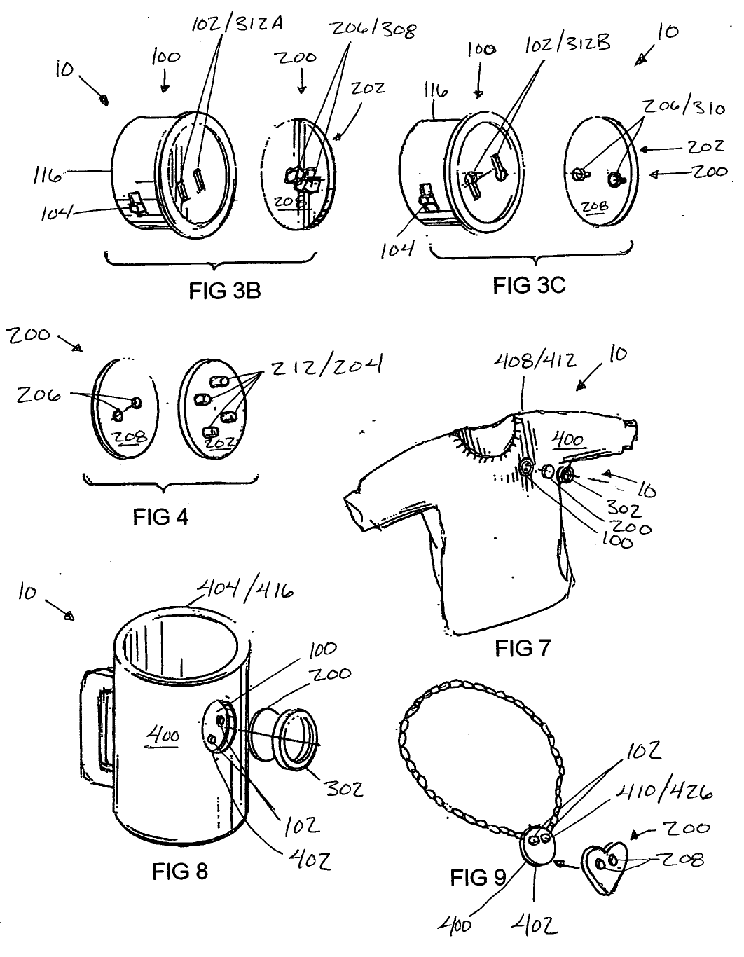

In accordance with another embodiment of the present invention, an illumination device 200 for use as an attachable lighted display is depicted in FIGS. 3A, 3B, 3C, and 4. It consists essentially of: a front viewing surface 202; means for emitting light from the front viewing surface 202 in response to an electrical signal received by the illumination device 200; electrical contacts 206 electrically coupled to the light emitting means 210 or 212; and coupling means 300 for coupling an external electronic display driver 100 to the electrical contacts 206. The light emitting means may be one or several an EL lamps 210, one or several LEDs 212 (see FIG. 4), a filament bulb (not shown), a florescent bulb (not shown), or any other mechanism for emitting light in response to an electrical signal, or any combination of these elements.

Preferably, the front viewing surface 202 comprises a deposited layer 214 forming a visual pattern 216 such as depicted in FIG. 10. The deposited layer is preferably provided by a method such as silk-screening or printing directly onto the front viewing surface 202. However, is should be clearly understood substantial benefits may be obtained by the front viewing surface 202 not comprising a deposited layer 214 forming a visual pattern 216, and instead a visual pattern 216 may be formed by other methods, for example, by supplying an external film (not shown) having a visual pattern 216, or no visual pattern 216 may be provided at all.

Various coupling means 300 may be used to couple an attachable lighted display such as an illumination device 200 to a driver device 100. In accordance with an embodiment of the present invention, the coupling means 300 comprises a peripheral retaining element 302 for encompassing at least a portion of the periphery of an attachable lighted display. As described previously, the peripheral retaining element 302 may be a ring having clasps 304 to engage a protruding lip 106 of a driver device 100 as depicted in FIGS. 1 and 1A. An alternative embodiment is shown in FIGS. 2 and 2A, where the peripheral retaining element 302 has threads 314 for engaging threads 314 on a driver device 100. FIG. 2A shows a partial cross-sectional view of the threaded peripheral retaining element 302 engaging threads 314 on a driver device 100 to secure the illumination device 200 to the driver device 100 so that the input contacts 108 of the illumination device 200 are in contact with the output contacts 102 of the driver device.

Although the peripheral retaining device 302 depicted in FIGS. 1 and 2 is a ring, it should be clearly understood that substantial benefits may be obtained by having the peripheral retaining device 302 not being a ring so long as it encompasses at least a portion of the periphery of an attachable lighted display. For example, the peripheral retaining device may encompass only two sides of a square attachable lighted display, or as another example, the peripheral retaining element 302 may only encompass a single portion of the periphery of an attachable lighted display, such as by using a clasping mechanism (not shown). Additionally, it is within the spirit and scope of the present invention that the peripheral retaining element 302 not use clasps 304 or threads 314, as long as the peripheral retaining element 302 can be coupled to a driving device 100. For example, adhesives, magnetism, hook and loop materials, or frictional contact may be used to secure the peripheral retaining element 302 to the driver device 100.

In accordance with another embodiment of the present inventions, the coupling means 300 comprises magnetic means 306 for magnetically coupling. FIG. 3A depicts magnetic or ferromagnetic coupling elements 306 for magnetically coupling the illumination device 200 to a driver device 100. As depicted in FIG. 3A, the magnetic coupling elements 306 also function as the output contacts 102 of the driver device 100 and the input contacts 206 of the illumination device, the magnetic coupling elements 306 may not also function as the output contacts 102 or the input contacts 206, and instead be additional structures on one of the driver device 100 or the illumination device 200, or both.

FIG. 3B depicts the coupling means 300 as the input contacts 206 of an illumination device 200 being a pair of clips 308 dimensioned to engage a portion of a driving device 100 such as apertures 312A. FIG. 3C depicts the coupling means 300 as the input contacts 206 being posts 310 dimensioned for inserting through apertures 312B in a driving device 100 and securing to the driving device by providing a twisting motion. To electrically couple the illumination devices 200 to the driver devices 100 of FIGS. 3B and 3C, the output contacts 102 of the driver devices 100 are proximate the apertures 312A and 312B. Although in FIGS. 3B and 3C the electrical contacts 208 also function as the coupling means 300, it should be clearly understood that the depicted coupling means 300, as well as other coupling means such as threaded fastening, adhesive, hook and loop materials, and frictional contact, may not be preformed by the electrical contacts 208 and instead be performed by other structures of the illumination device 200. For example, the illumination device 200 depicted in FIG. 3B may have clips 308 and also separate electrical contacts 208 such as depicted in FIGS. 1 and 2. It should also be clearly understood that substantial benefit may be obtained by having the clips 308 and posts 310 not being proximate the attachable lighted display and instead be proximate the driver device 100, and the corresponding apertures 312A and 312B being defined by the attachable lighted display.

Referring now to FIGS. 7-15, and in particular FIG. 11, the modular lighted display 10 of present invention preferably further comprises a mounting surface 400 defining an aperture 402, with the aperture 402 being dimensioned so that a portion of the driver housing 116 is insertable therethrough. The driver housing 116 is preferably coupled to the mounting surface 400 with a portion of said driver housing 116 being positioned through the aperture 402 so that the output contacts 102 of the driver device 100 are substantially flush with the mounting surface 400. In this manner, the driver device 100 is substantially hidden from view and an attachable lighted display such as an illumination device 200 may be attached to give the appearance of being mounted directly to the mounting surface 400. Although FIGS. 7-15 depict a single lighted display 10 on each mounting surface 400, it should be clearly understood that substantial benefits may be obtained by having multiple lighted displays 10 on a single mounting surface 400. For example, a collection of lighted displays 10 may be mounted on a single surface for hanging on a wall, such as for displaying a collection of illuminated sports team logos.

Preferably, the mounting surface 400 is an exterior surface of at least one of a promotional-type item 404, a collectable-type item 406, an article of clothing 408, and an article of jewelry 410. These categories of items share the common characteristic of being items of personal use commonly provided with lighted displays for attention-commanding effects on observers.

FIGS. 7 and 11 depict embodiments of the present invention wherein the mounting surface 400 is an exterior surface of an article of clothing 408. In FIG. 7, the article of clothing 408 is a sweatshirt 412. In FIG. 11, the article of clothing 408 is a hat 414. The exterior surface of other articles of clothing 408 may be used as a mounting surface 400, including, but not limited to, shoes, is shoelaces, belts, neckties, jackets, and helmets.

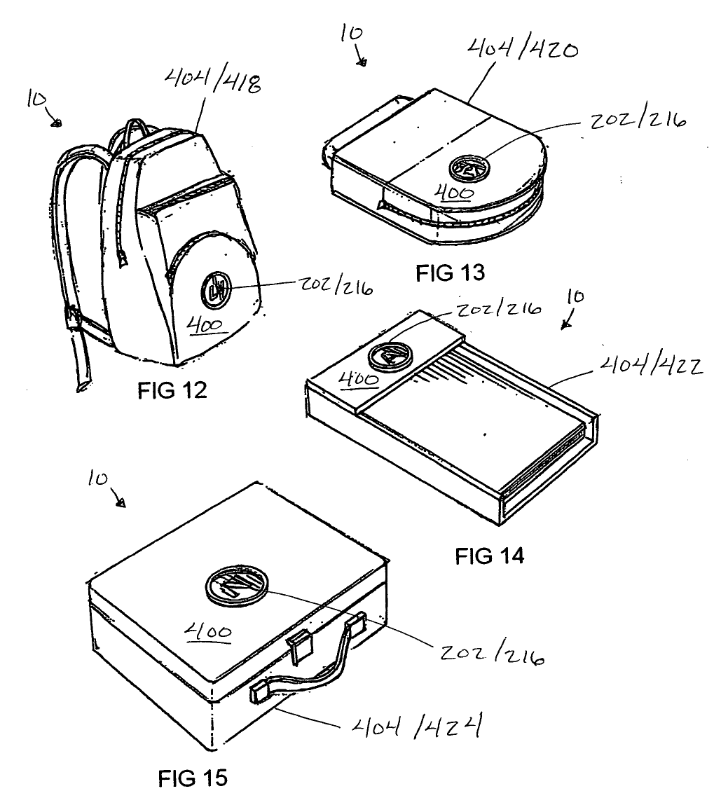

FIGS. 8 and 12-15 depict embodiments of the present invention wherein the mounting surface 400 is an exterior surface of a promotional-type item 404. These items share the common characteristic of frequently being given by companies to potential customers as a means of promoting or advertising the companies' products or services. In FIG. 8, the promotional-type item 404 is a cup 416. In FIG. 12, the promotional-type item 404 is a backpack 418. In FIG. 13, the promotional-type item 404 is a compact disc carrying case 420. In FIG. 14, the promotional-type item 404 is a memo pad container 422. In FIG. 15, the promotional-type item 404 is a lunchbox 424. The exterior surface of other promotional-type items 404 may be used as a mounting surface 400, including, but not limited to, mugs and coffee cups, sports bottles, notebooks, briefcases, sports bags, name tags, Christmas ornaments, cell phone cases, and other common office products such as mouse pads.

FIG. 9 depicts an embodiment of the present invention wherein the mounting surface 400 is an exterior surface of an article of jewelry 410. In FIG. 9, the article of jewelry 410 is a pendant 426 on a necklace. The exterior surface of other articles of jewelry 410 may be used as a mounting surface 400, including, but not limited to, watches, rings, bracelets and earrings.

FIG. 10 depicts an embodiment of the present invention wherein the mounting surface 400 is an exterior surface of a collectable-type item 406. In FIG. 10, the collectable-type item 406 is a baseball 428. The exterior surface of other collectable-type items 406 may be used as a mounting surface 400, including, but not limited to, picture frames, trophies, toys, bookmarks, key chains, purses and handbags, snow globes, badges, and containers such as cookie jars, jewelry boxes, piggy banks, and vases.

While the invention has been particularly shown and described with reference to the preferred embodiments thereof, it will be understood by those skilled in the art that the foregoing and other changes in form, and details may be made therein without departing from the spirit and scope of the invention. For example, the mounting surface 400 may be an exterior surface of a car (not shown).

1. An electronic driver device for an attachable lighted display, comprising, in combination:
input contacts for receiving an electrical input;
a driver circuit coupled to said input contacts for transforming said electrical input to illuminate an attachable lighted display;
output contacts coupled to said driver circuit; and
display coupling means for coupling an attachable lighted display into electrical contact with said output contacts.

2. The device of claim 1, wherein said display coupling means comprises a peripheral retaining element for encompassing at least a portion of the periphery of an attachable lighted display.

3. The device of claim 1, wherein said display coupling means comprises magnetic means for magnetically coupling said attachable lighted display in contact with said output contacts.

4. The device of claim 1, wherein said driver circuit comprises an inverter for illuminating an electroluminescent lamp.

5. The device of claim 1 further comprising a driver housing having an interior and an exterior, said driver circuit being proximate said interior of said driver housing, said output contacts being proximate said exterior of said driver housing.

6. The device of claim 5, further comprising a mounting surface defining an aperture, said aperture being dimensioned so that a portion of said driver housing is insertable therethrough, said driver housing being coupled to said mounting surface with said portion of said driver housing being positioned through said aperture so that said output contacts are substantially flush with said mounting surface.

7. The device of claim 6 wherein said mounting surface is an exterior surface of at least one of a promotional-type item, a collectable-type item, an article of clothing, and an article of jewelry.

8. The device of claim 7 wherein said mounting surface is an exterior surface of a hat.

9. The device of claim 7 wherein said mounting surface is an exterior surface of a cup.

10. The device of claim 7 wherein said mounting surface is a surface of a pendant.

11. The device of claim 7 wherein said mounting surface is an exterior surface of a backpack.

12. The device of claim 7 wherein said mounting surface is an exterior surface of a compact disc storage case.

13. The device of claim 7 wherein said mounting surface is an exterior surface of a memo pad container.

14. The device of claim 7 wherein said mounting surface is an exterior surface of a lunchbox.

15. The device of claim 5 wherein said driver housing further comprising a battery compartment.

16. An illumination device for use as an attachable lighted display consisting essentially of:
a front viewing surface;
a back surface;
electroluminescence means for emitting light from said front viewing surface in response to an electrical signal received by said illumination device; and
electrical contacts proximate said back surface and electrically coupled to said electroluminescence means for receiving said electrical signal.

17. The device of claim 16 wherein said front viewing surface comprises a deposited layer forming a visual pattern.

18. An illumination device for use as an attachable lighted display consisting essentially of:
a front viewing surface;
means for emitting light from said front viewing surface in response to an electrical signal received by said illumination device;
electrical contacts electrically coupled to said light emitting means; and
coupling means for coupling an external electronic display driver to said electrical contacts.

19. The device of claim 18 wherein said coupling means comprises magnetic means for magnetic coupling.

20. The device of claim 18 wherein said front viewing surface comprises a deposited layer forming a visual pattern.

21. A modular lighted display device comprising, in combination:
a driver device having output contacts for supplying an electrical signal;
an illumination device having a front viewing surface and means for emitting light from said front viewing surface in response to said electrical signal from said driver device, said illumination device further having input contacts electrically coupled to said light emitting means for receiving said electrical signal; and
means for coupling said illumination device to said driver device so that said electrical signal is transmitted between said output contacts of said driver device and said input contacts of said illumination device.

22. The device of claim 21 wherein said light emitting device comprises an electroluminescence lamp, said driver device further comprises input contacts for receiving an electrical input, said driver device further comprises a driver circuit coupled to said input contacts and to said output contacts for transforming said electrical input into said electrical signal for powering said electroluminescence lamp.

23. The device of claim 21 wherein said light emitting means comprises a light emitting diode.

24. The device of claim 21 wherein said coupling means comprises a peripheral retaining element for encompassing at least a portion of the periphery of said illumination device, said peripheral retaining element is removably coupled to said driver device.

25. The device of claim 21 wherein said coupling means comprises magnetic means for magnetically coupling said illumination device to said driver device.

26. A method for providing an illuminable display to an item, comprising the steps of:
providing a mounting surface for said illuminable display;
providing a display device for providing an electrical signal for an illumination device, said display device comprising means for coupling said illumination device to said driver device so that said illumination device is electrically coupled to said driver device, said driver device further comprising means for coupling said driver device to said mounting surface;
coupling said driver device to said mounting surface;
providing an illumination device comprising a viewing surface and means for emitting light from said viewing surface in response to said electrical signal from said driver device; and
coupling said illumination device to said driver device.

27. The method of claim 24, wherein said mounting surface is an exterior surface of one of a promotional-type item, a collectable-type item, an article of clothing, and a piece of jewelry.
